(19) United States
(12) Patent Application Publication
(10) Pub. No.: US 2009/0005114 A1
(43) Pub. Date: Jan. 1, 2009

(54) Intelligent shortcut multi-channel reminding method and means for portable device

(75) Inventors: Qianying Wang, Beijing (CN); Wen Wang, Beijing (CN); Yan Li, Beijing (CN); Xiaoli Du, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Lenovo (Beijing) Limited, Beijing (CN)

(21) Appl. No.: 12/215,779

(22) Filed: Jun. 30, 2008

(30) Foreign Application Priority Data
Jun. 28, 2007 (CN) 200710118086.8

(51) Int. Cl. H04M 1/00

(52) U.S. Cl. 455/556.2

(57) ABSTRACT

The present invention discloses an intelligent shortcut multi-channel reminding method for a portable device, which provides a to-be-processed field for a communication record to be processed when attaching a to-be-processed tag to the communication record, and stores the to-be-processed field together with the communication record. The present invention further discloses an intelligent shortcut multi-channel reminding means for a portable device based on the method, which comprises a to-be-processed module including more than one to-be-processed sub-modules which share a storage space with communication functional modules and serve to view, add, modify and delete to-be-processed fields; at least one shortcut channel which enables information delivery between each to-be-processed sub-module and the corresponding communication functional module; a reminding module which connects to each of the to-be-processed sub-modules and pops up a reminding interface according to the setting of to-be-processed tags. The present invention has advantages of simple operation, no limitation in terms of use environment for various communication function reminding, no reliance on any operator and no additional fee.

### BACKGROUND OF THE INVENTION

1. Field of Invention

The present invention relates to the processing field of the communication transaction of a portable device, and in particular to an intelligent shortcut multi-channel reminding method and means for a portable device.

2. Description of Prior Art

As daily contact and communication keeps growing for people, especially those in business industry, and various communication approaches are expanding, people's everyday schedule is more and heavier and information source becomes diversified. Some affairs may be forgotten and absent from timely handling if those affairs are merely dependent on the memorization of human brain. As a result, a portable device having the function of schedule reminding turns out to be a useful assistant for businessmen.

Some existing patent applications have been disclosed relating to the reminding of call, telephone, short message and mailbox, however, these solutions each have different levels of defects in different respects.

Specifically, an existing method is used for call reminding and automatic dialing, which can remind a user to set a call for a certain telephone number at a pre-programmed time, and if the call is confirmed at the time of issuing the call reminder, an automatic dialing is performed; on the other hand, if the dialing is temporally not performed, the reminding can be delayed to a certain period or be cancelled. This solution only combines the call with the reminding function, and thus it has limitations under the situation of a portable device having several communication forms of mail, short message and the like.

Another present method is used for reserving the mailbox of a mobile phone, which enables schedule reminding by use of a voice mailbox. In this method, a user can enter the mailbox, leave a message in the mailbox and set the time when a reply from the mailbox is expected; upon the set time, the message left in the mailbox dials automatically the number of the mobile phone to remind the user of any necessary journey or meeting. Such voice message reminding method, however, is limited in terms of application places, for example, the setting of voice reminding is inconvenient during a meeting or under a noisy environment and thus can not be implemented regardless of place and time. Moreover, this method has a poor efficiency since it has a time-consuming operation of entering the mailbox, recording a message and then setting the reminding time.

A present technology discloses a short-message-based reminding service means and its method, which reminds a user with a short message. In this solution, the user needs to send the time and content to be reminded to a server in advance, and the server sends a reminding short message to the user at the set time for helping the user with schedule arrangement. The method requires editing a short message in the process of setting a reminding message and thus is poor in efficiency. Further, the reminding function by a short message needs support from an operator's server, and the coverage of service network of the operator has influence on the implementation of the reminding function by a short message. Also, a service fee may be generated depending on the charging policy of the operator.

### SUMMARY OF THE INVENTION

In view of the above problems, the primary object of the present invention is to provide an intelligent shortcut multi-channel reminding method for a portable device, which does not need a support from an operator and enables a timely and intelligent reminding function wherever and whenever.

A further object of the present invention is to provide an intelligent shortcut multi-channel reminding means for a portable device, which supports an intelligent reminding function with respect to various communication methods in a simple, rapid and convenient manner.

The technical solution of the present invention is proposed below in order to achieve the above objects.

An intelligent shortcut multi-channel reminding method for a portable device provides a to-be-processed field for a communication record to be processed when attaching a to-be-processed tag to the communication record, and stores the to-be-processed field together with the communication record.

Providing a to-be-processed field for a communication record to be processed consists of providing a to-be-processed field for each communication record, and at the time of attaching a to-be-processed tag, setting the to-be-processed field for the communication record to be attached with the to-be-processed tag in a to-be-processed status; or

Providing a to-be-processed field for a communication record to be attached with a to-be-processed tag only at the time of attaching the to-be-processed tag.

The above method further comprises storing as a separate list all communication records each attached with a to-be-processed tag.

The above method further comprises querying, modifying, replying or deleting any of the communication records to be processed in said list.

One or more subfields for setting to-be-processed information are provided for the to-be-processed field; the above method further comprises setting the value of each subfield in the to-be-processed field by clicking the to-be-processed tag.

Information corresponding to said subfield includes, but not limited to, a reply manner, a reminding manner, a reminding time, a reminding delay time and remarks.

The above method further comprises setting a periodic reminding manner and a reminding time so that, every time the reminding time is reached, a user is reminded to process a corresponding communication record to be processed.

The above method further comprises resetting the information corresponding to the one or more subfields.

Said communication record includes, but not limited to, short message record, call record and E-mail record.

An intelligent shortcut multi-channel reminding device for a portable device comprises:

more than one to-be-processed sub-modules which share a storage space with communication functional modules and serve to view, add, modify and delete to-be-processed fields;

at least one shortcut channel which enables information delivery between each to-be-processed sub-module and the corresponding communication functional module.

Said communication functional modules are a short message module, an E-mail module and a call module; said to-be-processed sub-modules are a to-be-processed short message module, a to-be-processed E-mail module and a to-be-processed call module.

Each of said to-be-processed sub-modules is embedded in the corresponding communication functional module in terms of function; or

all of said to-be-processed sub-modules constitute a to-be-processed module together.

Said means further comprises a reminding module which connects to each of the to-be-processed sub-modules and pops up a reminding interface according to the setting of to-be-processed tags.

The intelligent shortcut multi-channel reminding method and means for a portable device provided by the present invention provide and store a particular to-be-processed tag for each communication record to be reminded, and the application of such tag can be extended by designing it as a tag having the settable function. Thus, the present invention has the following advantages:

1) the reminding information of the present invention is applicable to various cases, such as short message, mail or call record, and the user can attaches the reminding information with great convenience;

2) in the present invention, attaching a tag to a corresponding communication record requires only a click on the corresponding button or icon, thus the setting of the reminding tag is not constrained from the aspect of environment, and the user can perform the reminding setting if necessary even at a meeting or on a noisy occasion;

3) the process of reminding setting in the present invention can be fulfilled on a terminal device without support from any operator and thus invulnerable to the network condition of the operator as well as the generation of any additional fee;

4) the reminding module in the present invention can be added with a function of setting the support to direct replay and also with a function of further setting information parameters so that the user can make the reminded reply directly to the other communication party or set the information parameters in a convenient and rapid way.

### BRIEF DESCRIPTION OF THE DRAWINGS

FIG. 1 is a schematic diagram showing the connection between respective communication functional modules and a to-be-processed module in a potable device;

FIG. 2 is a schematic diagram of a communication function interface containing the option of attaching a to-be-processed tag;

FIG. 3 is a schematic diagram of to-be-processed tags;

FIG. 4 is a flowchart of attaching a to-be-processed tag;

FIG. 5 is a flowchart of deletion operation on a to-be-processed sub-module;

FIG. 6 is a flowchart of reminding function of a to-be-processed tag having the reminding function.

### DETAILED DESCRIPTION OF PREFERRED EMBODIMENTS

The basic idea of the present invention is to mark a communication record to be processed later by a user through attaching a tag to-be-processed, and remind the user to process the communication record in various manners by further setting such parameter information as reminding content, reminding manner and remarks in the tag to-be-processed; and to support the user's direct reply to a selected object upon the popup of reminding by setting a reply function, thereby facilitating the user's handling.

In the present invention, attaching a to-be-processed tag is that adds a to-be-processed field to each communication record, and indicates whether corresponding communication record is in a to-be-processed status by setting the value of the field as “YES” or “NO”, where “YES” indicates that it is in the to-be-processed status, and “NO” indicates that it is not to be processed or it is in a processed status. In general, the initial value of the field is “NO”. Moreover, attaching a to-be-processed tag is that a to-be-processed field can be added to only a communication record which needs to be identified as to-be-processed. In this case, any communication record containing a to-be-processed field is one needed to be processed, and any communication record containing no to-be-processed field belongs to what needs no processing or has been processed. Accordingly, the to-be-processed field should be deleted after the processing of each communication record to-be-processed is completed.

For the set field to-be-processed, more subfields can be added by setting a data structure based on different communication records so as to set more information, such as reminding time, reminding manner, reply manner, reminding delay time, remarks and the like. The values of respective subfields in a to-be-processed field can be further set by clicking a to-be-processed tag to enter a setup interface for subfield.

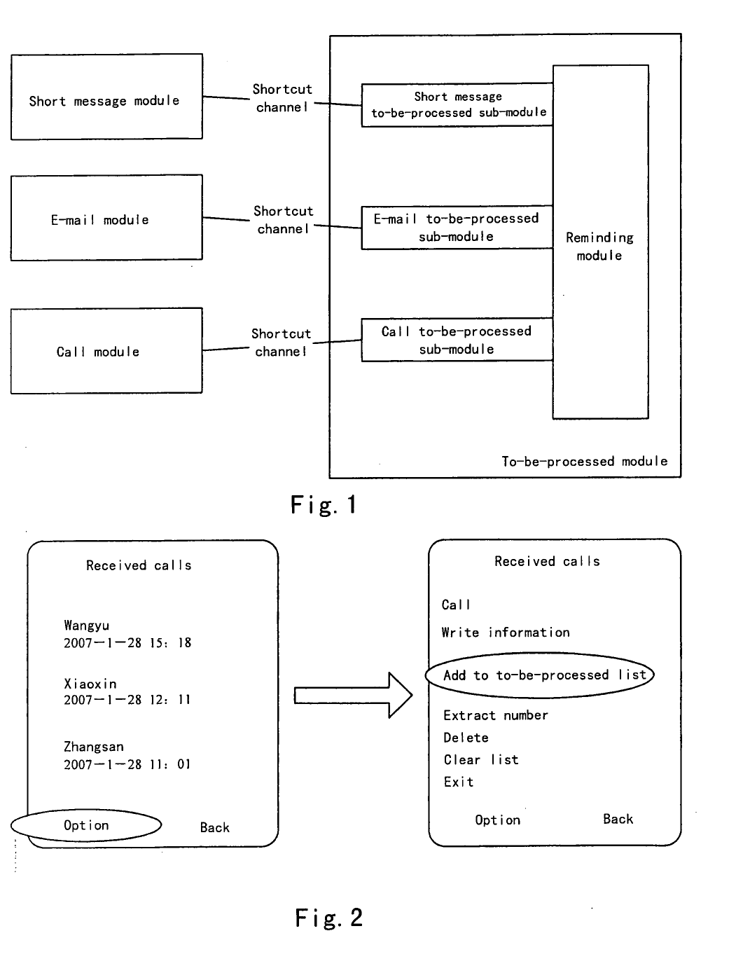

Each of communication functional modules in the existing portable device can save communication records directly. The present invention adds a to-be-processed field to each of the existing communication records and attaches a to-be-processed tag to the corresponding communication record by setting the information of the to-be-processed field. As shown in FIG. 1, the intelligent shortcut multi-channel reminding means for a portable device provided by the present invention comprises a to-be-processed module and at least one shortcut channel connected to communication functional modules, which are inherent to the portable device and include one or more types, such as short message module, E-mail module, call module, etc. The to-be-processed module enables various operations on a to-be-processed field, such as addition, modification, deletion and the like. The to-be-processed module further have more than one to-be-processed sub-modules corresponding to different communication functional modules, such as short message to-be-processed sub-module, E-mail to-be-processed sub-module, and call to-be-processed sub-module, etc. Each of these to-be-processed sub-module shares the storage space of a corresponding communication functional module, that is, shares a storage space with a specified address in the existing storage module of the portable device. Moreover, each of the to-be-processed sub-modules respectively performs information delivery with the corresponding communication functional module via one shortcut channel so that the to-be-processed sub-modules can share modification information about the to-be-processed tag in synchronization with the corresponding communication functional module. The to-be-processed module further comprises a reminding module for reminding a user to process or reply to to-be-processed communication records. The reminding module is connected to each of the to-be-processed sub-modules and can pop up a reminding interface at a set time in front of the current interface of the portable device.

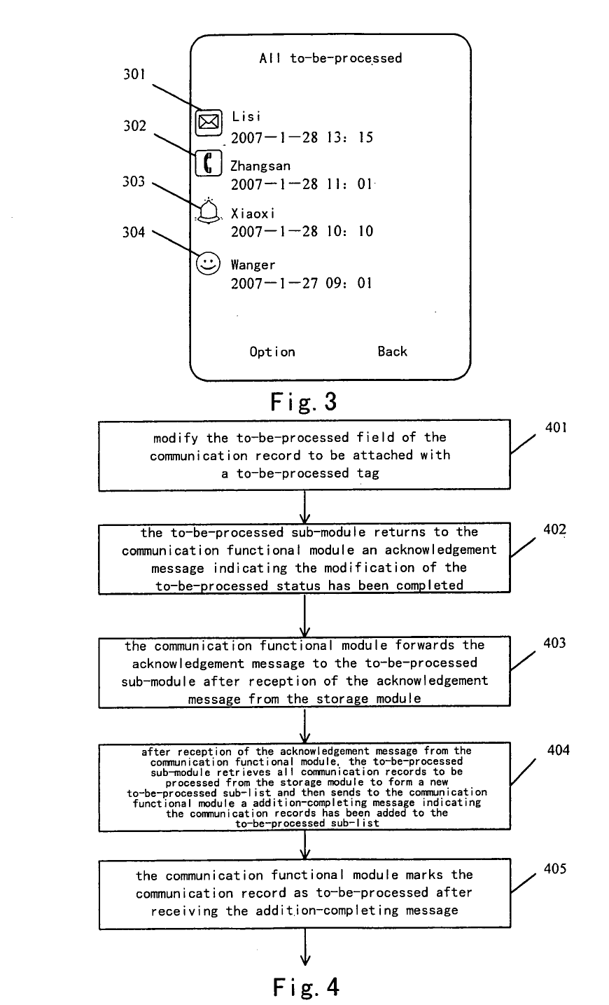

After the call module as shown in FIG. 2 being added the to-be-processed module, if the user wants to provide a to-be-processed tag for one or more selected communication records and then clicks an option, an option of “add to to-be-processed list” will appear in the popup function selections. After choosing this option, an icon or symbol appears on the corresponding communication records, as shown in FIG. 3, to give a visual reminding. Meanwhile, such communication record having a set to-be-processed tag is automatically added to a list of to-be-processed sub-modules which is specifically provided via the shortcut channel, so that the user can enter the to-be-processed sub-module through the selection of the current communication functional module and view all communication records having to-be-processed tags attached.

From the perspective of each of these different communication records, the reminding patterns of their attached to-be-processed tags can be the same or vary with different communication functions. As shown in FIG. 3, the reference numbers 301 to 304 are different to-be-processed tags attached depending on communication functions, where the to-be-processed tag 301 indicates there is a short message to be processed, the to-be-processed tag 302 indicates there is a phone call to be processed, the to-be-processed tag 303 indicates there is a log to be processed, and the to-be-processed tag 304 indicates this business has been processed.

As shown in FIG. 4, the process of adding a to-be-processed tag to a communication record comprises the following steps.

Step 401: modifying the to-be-processed field of the communication record to be attached with a to-be-processed tag.

Normally, the communication records of a portable device are saved in its own dedicated storage module. Each of the communication records includes a to-be-processed field, the value of which will be modified to “YES” if a to-be-processed tag needs to be attached to the communication record. Thereafter, the communication record with a modified value of its to-be-processed field is stored at a corresponding location in the storage module via the corresponding to-be-processed sub-module.

Step 402: the storage module returns, to the communication functional module, an acknowledgement message indicating the modification of the to-be-processed status has been completed.

Step 403: the communication functional module forwards an acknowledgement message to the to-be-processed sub-module after reception of the acknowledgement message from the storage module.

Step 404: after reception of the acknowledgement message from the communication functional module, the to-be-processed sub-module retrieves all communication records to be processed from the storage module to form a new to-be-processed sub-list and then sends to the communication functional module a addition-completing message indicating the communication records has been added to the to-be-processed sub-list.

The detail of the above retrieval is that the to-be-processed sub-module re-searches the communication records of all to-be-processed tag attached having corresponding communication functions in the storage module, forms a new to-be-processed sub-list by using the newly found communication records corresponding to the different communication functions and stores them at a corresponding location in the storage module. Each type of to-be-processed sublist is formed in the similar way. If a to-be-processed general list is to be formed, then the to-be-processed module, when the user enter it, directly retrieves all communication records to be processed in the storage module to form the to-be-processed general list. When a certain communication record having an attached to-be-processed tag is modified, the corresponding modification will made to the information on this communication record in the to-be-processed general list and each to-be-processed sub-list.

In practice, it is feasible to form only the to-be-processed general list. The retrieval can be carried out with respect to a certain communication record or communication record having a type of communication function, such as short message, E-mail, call, etc.

Step 405: the communication functional module marks the communication record as to-be-processed after receiving the addition-completing message.

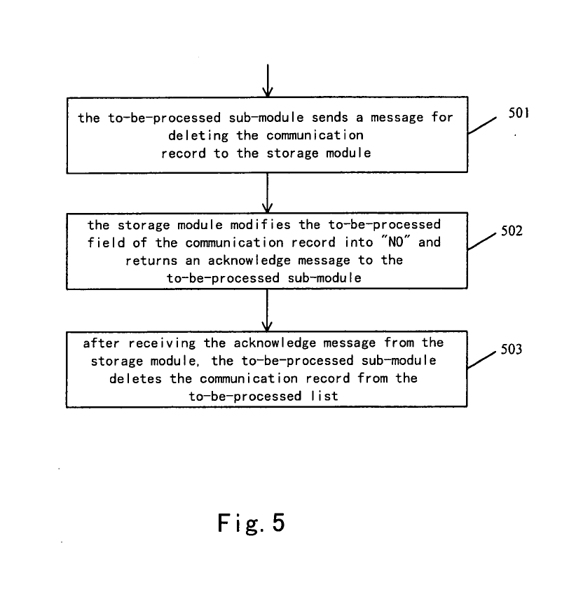

Here, the to-be-processed list can be formed as to-be-processed sub-lists corresponding to different communication functions in terms of diversity in communication function, such as short message to-be-processed list, E-mail to-be-processed list, call to-be-processed list, etc. Also, as shown in FIG. 3, a to-be-processed general list can be formed containing all communication records each having a to-be-processed tag attached. The user can operate, for example, view, modify, and delete, etc., the communication records in each to-be-processed sub-list through the corresponding communication functional module. The user can enter the to-be-processed module to manipulate the list containing all of the records to be processed, or can enter a to-be-processed sub-module to manipulate a corresponding to-be-processed sub-list. FIG. 5 shows the process of deleting a communication record attached with a to-be-processed tag from a to-be-processed sub-module, which comprises the following steps.

Step 501: the to-be-processed sub-module sends a message for deleting the communication record to the storage module;

Step 502: the storage module modifies the to-be-processed field of the communication record into “NO” and returns an acknowledge message to the to-be-processed sub-module;

Step 503: after receiving an acknowledge message from the storage module, the to-be-processed sub-module deletes the communication record from the to-be-processed sub-list.

The above illustrates a simple reminding method. The present invention offers a more powerful reminding function of specifically setting a to-be-processed tag, which includes but not limited to the reminding time, reminding manner, interval period between reminding times, reply manner, remarks, etc. If a reply manner is set, the portable device can remind the user to reply by popping up a reminding interface at a pre-set time so that the user can make a proper and rapid reply by directly clicking on the reply.

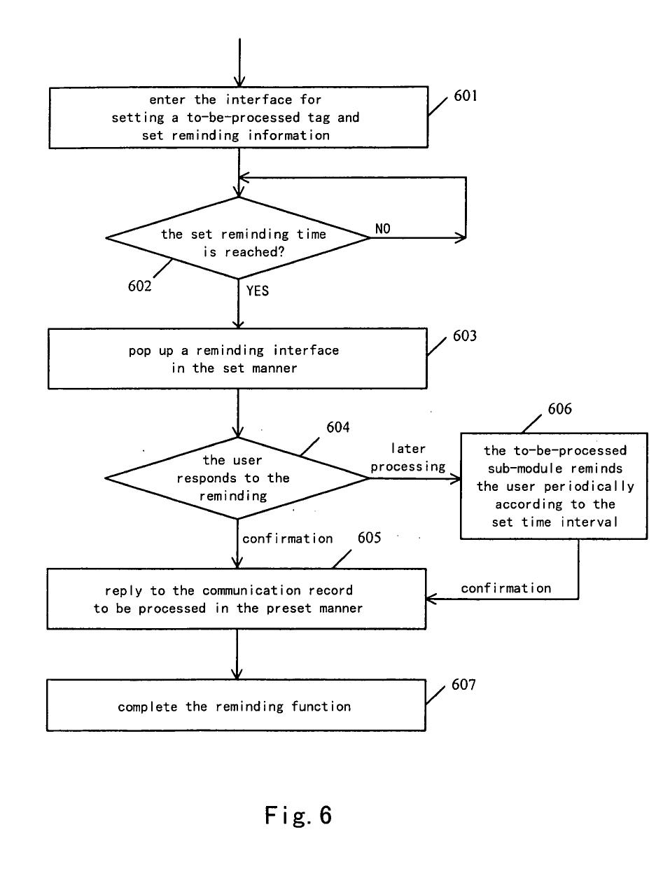

If the user needs to set reminding time and reminding manner after attaching a to-be-processed tag, such intelligent reminding comprises the following steps as shown in FIG. 6.

Step 601: entering the interface for setting a to-be-processed tag and setting reminding information, such as reminding time, manner, interval period, reply manner, remarks, etc.; the set reminding information belongs to part of the attached to-be-processed tag and will be stored together with the corresponding communication record;

Step 602: determining whether the set reminding time is reached, continuing to wait and make a real-time or periodic determination if it is up to the set time, and proceeding to step 603 if the set time has been reached;

Step 603: popping up a reminding interface in the set manner of, for example, vibration, ringing or the like;

Step 604: the user responds to the reminding, and subsequent processing is performed depending on different response information, such as proceeding to step 605 if confirmation is selected, or proceeding to step 606 if later processing is selected;

Step 605: the user replies to the communication record to be processed in the preset manner, such as dialing the number of the communication object directly, sending a short message or a mail, etc., without entering the communication address book for searching the associated communication object; then the flow proceeds to step 607 after the reply is fulfilled;

Step 606: the to-be-processed sub-module reminds the user periodically according to the set time interval; after the user selects confirmation every time the reminding interface pops up, the flow turns to step 605;

Step 607: the reminding function has been completed and the communication record remains in the to-be-processed sub-list, but the to-be-processed tag is changed from “to-be-processed” to “completed”.

The user can enter the to-be-processed interface to delete the to-be-processed communication record that has been processed, or delete it at step 607. The periodic reminding function at step 606 can be provided as resetting the reminding time, manner and the like, in other words, reminding the user only once instead of periodic reminding. The user, when reminded, may reset the subsequent reminding time and reminding manner. The reminding time length and reminding manner can be set identically or differently each time so as to meet the user's requirement.

The above technical solution can be embodied in a simplified way as directly embedding respective to-be-processed sub-module to corresponding communication functional modules in terms of diversity in function, so that to-be-processed sub-lists attached with to-be-processed tags can be view directly via the communication functional modules without the provision of a dedicated to-be-processed module, and accordingly there is no general list containing all communication records to be processed.

The above description illustrates only the preferred embodiments of the present invention other than limiting the scope of the present invention in any respect.

1. An intelligent shortcut multi-channel reminding method for a portable device characterized by providing a to-be-processed field for a communication record to be processed when a to-be-processed tag is attached to the communication record, and storing the to-be-processed field together with the communication record.

2. The intelligent shortcut multi-channel reminding method for a portable device of claim 1, characterized in that providing the to-be-processed field for the communication record to be processed comprises:
providing the to-be-processed field for the communication record, and at the time of attaching the to-be-processed tag, setting the to-be-processed field for the communication record which is to be attached with the to-be-processed tag in a to-be-processed status; or
providing the to-be-processed field for the communication record which is to be attached with the to-be-processed tag only at the time of attaching the to-be-processed tag.

3. The intelligent shortcut multi-channel reminding method for a portable device of claim 2, further comprising storing all communication records attached with to-be-processed tags as a separate list.

4. The intelligent shortcut multi-channel reminding method for a portable device of claim 3, further comprising querying, modifying, replying or deleting any of the communication records to be processed in said list.

5. The intelligent shortcut multi-channel reminding method for a portable device of claim 2, characterized in that one or more subfields for setting to-be-processed information are provided for the to-be-processed field; and the method further comprises further setting the value of each subfield in the to-be-processed field by clicking the to-be-processed tag.

6. The intelligent shortcut multi-channel reminding method for a portable device of claim 5, characterized in that information corresponding to said subfield includes at least one of reply manner, reminding manner, reminding time, reminding delay time and remarks.

7. The intelligent shortcut multi-channel reminding method for a portable device of claim 5, further comprising setting a periodic reminding manner and a reminding time so that, every time the reminding time is reached, a user is reminded to process a corresponding communication record to be processed.

8. The intelligent shortcut multi-channel reminding method for a portable device of claim 6, further comprising resetting the information corresponding to the one or more subfields.

9. The intelligent shortcut multi-channel reminding method for a portable device of claim 1, characterized in that said communication record includes at least one of a short message record, a call record and an E-mail record.

10. An intelligent shortcut multi-channel reminding device for a portable device by comprising:
a plurality of to-be-processed sub-modules which share a storage space with communication functional modules and are used to view, add, modify and delete to-be-processed fields; and
at least one shortcut channel which enables information delivery between each to-be-processed sub-module and a corresponding communication functional module.

11. The intelligent shortcut multi-channel reminding device for a portable device of claim 10, characterized in that said communication functional modules are at least one of a short message module, an E-mail module and a call module; and said to-be-processed sub-modules are at least one of a to-be-processed short message module, a to-be-processed E-mail module and a to-be-processed call module.

12. The intelligent shortcut multi-channel reminding device for a portable device of claim 10, characterized in that:
each of said to-be-processed sub-modules is embedded in the corresponding communication functional module in terms of function; or
all of said to-be-processed sub-modules constitute a to-be-processed module.

13. The intelligent shortcut multi-channel reminding device for a portable device of claim 10, characterized in that each of said device further comprises a reminding module which connects to each of the to-be-processed sub-modules and pops up a reminding interface according to settings of to-be-processed tags.
